(19) United States
(12) Patent Application Publication
(10) Pub. No.: US 2026/0307309 A1
(43) Pub. Date: Oct. 8, 2026

(54) METHOD FOR MANUFACTURING A TOILET SEAT

(71) Applicant: GEBERIT INTERNATIONAL AG, Jona (CH)

(72) Inventors: David Gmür, Jona (CH); Matthias Karl, Jona (CH)

(73) Assignee: GEBERIT INTERNATIONAL AG, Jona (CH)

(21) Appl. No.: 19/481,815

(22) PCT Filed: Apr. 19, 2024
(86) PCT No.: PCT/EP2024/060726

§ 371 Date: Nov. 5, 2025

(30) Foreign Application Priority Data
May 12, 2023 (EP) 23173086.2

(51) Int. Cl. B29C 45/14; A47K 13/30; B29C 45/16; B29L 31/00

(52) U.S. Cl. CPC B29C 45/14639; A47K 13/305; B29C 45/14819; B29C 45/1675; B29L 2031/7694

(57) ABSTRACT

The invention relates to the production of a toilet seat by inserting a seat heating 2 into a first mold formed from two mold parts 1 and 3, filling this mold with a flowable material and solidifying the material to produce a composite of the seat heating and this material in the mold.

The present invention relates to the manufacture of a toilet seat and in addition also to the manufacture of a toilet seat set additionally comprising a toilet cover and to the manufacture of a toilet equipped therewith.

Water toilets (toilets or WCs) regularly comprise a toilet body with a bowl and devices for the water flushing thereof as well as a toilet seat mounted on this toilet body. Typically, the toilet seat is mounted on the toilet body at one end in an articulated/pivotable and in this respect foldable manner and typically a toilet cover is also additionally provided. The toilet seat serves the user to sit over the bowl during use and accordingly comprises an opening over the bowl (wherein it does not necessarily have to be closed around the latter), whereas the toilet cover is intended to cover the bowl upwardly and in this respect is typically provided over the toilet seat and typically in turn also in a foldable/hinged manner. Sets of toilet cover and toilet seat fastened to one another and provided for mounting on a toilet body are also referred to as a toilet set.

In recent years, there are increasingly toilets with further technical functions, e.g. for abdominal cleaning after use or odor extraction and in addition also heaters for the toilet seat. These function by electrical resistance heating or, less frequently, by the heating of a heating layer in the toilet seat by means of induction. In both cases, a seat heating is integrated in the toilet seat, i.e., the electrical heating resistor or the inductively heatable layer, wherein, of course, further functional elements for supplying, controlling, in particular regulating, or as induction sources can be provided outside the toilet seat.

In practice, this raises the question of how to integrate the seat heating into the toilet seat, i.e., in particular the heating resistor or an inductively heatable layer mentioned above, during the manufacturing of the seat. If, in the usual manner, the toilet seat is assembled from a plurality of shell parts, e.g., a lower and an upper half shell, and a filling therebetween, the seat heating can be placed between these shell parts.

The present invention is based on the problem of specifying a manufacturing method which is advantageous with regard to a heatable toilet seat.

According to the invention, the problem is solved by a manufacturing method according to claim 1. In addition, however, the invention also relates to a corresponding manufacture of a toilet seat set according to claim 10 and of a toilet according to claim 11.

According to claim 1, it is intended to insert the seat heating into a (“first”) mold intended for the manufacture of at least a part of the toilet seat, before this mold is filled with the material used for the manufacture. This material solidifies in the mold after it has been inserted in a flowable state on at least one side of the seat heating. In the mold, there is a contact between the initially still flowable material and the seat heating, so that a composite with good adhesion between them can be formed. In particular, it is preferably intended that the flowable material wets the seat heating over a large area, e.g., substantially on the entire side (of a total of two sides of the seat heating). This applies in particular when the seat heating has a flat shape.

Of course, further method steps can follow, but this is not always necessary. This will be discussed in more detail later.

The seat heating to be inserted into the mold advantageously has a flat shape at least to the extent that it is held on a carrier film (which in this respect is thus virtually considered as part of the seat heating). For example, there can be wire structures or conductor tracks glued, printed, or otherwise fastened on a plastic film. The seat heating can also be defined lithographically and etched free on the carrier film, for example.

In addition, the seat heating per se can have a flat layer structure rather than a conductor track or wire structure, for instance because it is constructed from a conductive polymer, a conductive carbon layer or the like. However, a metallic wire or conductor track structure on a plastic film, in particular an ABS film, is preferred.

Preferably the carrier film remains in the first mold and thus becomes part of the composite. It can thus contribute to the above-mentioned flowable material lying flat on one side of the seat heating, but for example not penetrating on the other side. In addition, the carrier film facilitates the handling of the seat heating before and during the insertion into the mold.

According to a further embodiment, an electrical heating conductor of the seat heating is intended in relation to the final mounting position of the toilet seat on a lower side of the carrier film. “Below” thus does not relate here to situations during the manufacture, but rather to the situation when the toilet seat is mounted on the toilet body (in the folded-down state). The carrier film can thus be used for example for electrical insulation. For example, the carrier film could form the final seat surface or subsequently only be covered with a layer inadequate for the electrical insulation.

Instead or in addition thereto, the carrier film can prevent structures of the heating conductor from being formed on the final seat surface, for example because they cannot be sufficiently leveled or embedded in a subsequent coating method. During the above-described manufacturing process, however, the flowable material introduced into the first mold can flow around structures of the electrical heating conductor with a certain thickness and in this respect absorb these structures.

The flowable material introduced into the first mold can deform the seat heating, in particular including the carrier film, as a result of a pressure, for instance during the injection molding, and in the process press a little or completely in the direction of the tool wall. In this case, for instance, an originally substantially flat and planar mold can be converted into a curved mold and/or the seat heating can be brought close to a wall of the mold and/or the future upper surface of the toilet seat by the deformation. If heat is used in this connection, for example during the injection molding, this can of course facilitate the deformation of the seat heating, in particular of the carrier film. In this respect, the seat heating does not necessarily have to be prefixed in the final desired position in such applications, but rather can be prefixed, for example, in a preliminary position and can then be brought from this preliminary position into the final position as described, in particular at points not directly affected by the prefixing, cf. the exemplary embodiment.

For example, parts of the seat heating or of the carrier film can be fixed by clamping between two parts of the first mold, for instance by pins touching contact points on the seat heating, which then also ensure later accessibility of the contact points at these points. Additionally or alternatively, the seat heating or the carrier film could also be prefixed by a vacuum device, wherein the latter preferably lies on the side to which the seat heating is then subsequently deformed. In a preferred embodiment (cf. further below), this side is still coated later, so that any traces of vacuum channels do not have to be essential.

A position close to the upper surface improves the energy efficiency of the seat heating with regard to the desired surface temperature and the use of energy and also improves the response behavior after switching on.

In this case, a substantial distance does not necessarily have to be bridged; it can already be advantageous if the seat heating, for example with the carrier film, bears against a desired outer surface of the first mold under pressure and thus in a defined manner, which cannot easily be reliably ensured by simple insertion into the mold (if appropriate with positioning in the two other spatial directions).

The filling, described so far in general terms, of the first mold with flowable material and solidifying of the material can correspond to different technologies, in particular to the already mentioned injection molding, which is also preferred in the present case and relates to the introduction of thermoplastic material liquefied by heating. However, methods with thermosetting materials, which could be referred to as pressing or also as casting, are also conceivable.

The injection molding with thermoplastic materials enables the more precise manufacture of filigree molds and faster manufacturing processes in comparison with, for example, pressure-plastic materials. In particular, no or less reworking (for example on separating burrs) is required, wherein such reworking is disadvantageous not only because of the work effort but also because of the unavoidable surface damage. However, the injection molding requires comparatively expensive tools and machines.

The preferred thermoplastic material is ASA. This has in particular a considerable chemical similarity to the already mentioned preferred carrier film material ABS, so that a very good adhesion and a stable composite results between the two materials. If the seat heating itself (whether it is now conductor track-shaped or wire-shaped or flat) does not hinder/impede this contact, either because it is permeable or because it is arranged on the other side, then the adhesion between the material of the heating conductor itself (or an induction layer) and the flowable introduced material may be less important or irrelevant in this context.

If the carrier film lies outside the seat heating in relation to the finished toilet seat, it can form the finished surface of the toilet seat in a particularly simple embodiment. Preferably, however, it is still coated subsequently, specifically preferably by applying a further flowable material in a “second” mold. The second mold is referred to here in a conceptual delimitation from the previously mentioned mold (therefore referred to as the first mold). This second mold preferably adjoins the seat heating or carrier film on the other side in relation to the material introduced into the first mold, wherein this does not have to be the case at the same time as the process in the first mold and in particular the second mold can be formed at all only after the solidification of the material introduced into the first mold.

(Also) the second mold is preferably closed, wherein in principle, however, an open mold can also be used, for example, for pouring on the flowable material. The second mold can also mean a second injection molding step. Preferably, however, no thermoplastic material is used here, but the seat heating in the second mold is flooded with a material solidifying on account of chemical processes.

The flooding has various possible advantages in comparison with the use of a carrier film as a seat surface or also the injection molding. For example, certain materials which are less suitable for a film can be used for the flooding, but which are particularly advantageous as a toilet seat surface. According to the invention, on the one hand, polyurea is preferred, specifically on account of its long-term stability and insensitivity to discoloration (for instance by textile paints, soiling, etc.). On the other hand, however, polyurethane can also be a favorable choice, which is also preferred. In principle, significantly better transitions of the flooding material to the other material (in particular injection molding material) can be produced during the flooding in comparison with the carrier film as a surface and difficulties can be avoided by a film edge. The materials mentioned are a two-component materials (plus dye, if necessary), which can cure in the second mold.

The material thickness of the flooding material (that is to say perpendicular to the surface) is preferably not more than 2 mm, particularly preferably not more than 1.8 mm, 1.6 mm, 1.4 mm, 1.2 mm or even not more than 1 mm. On the other hand, the following lower limits for the material thickness are preferred: 0.2 mm, 0.3 mm, 0.4 mm and finally 0.5 mm.

For the feeding into the second mold, the flowable material can be guided through an inflow channel, which lies laterally in relation to the finished toilet seat in the folded-down mounted state and in relation to a cross-section (transversely to the direction of extent of the seat at this point, that is to say with minimal cross-section) through the seat ring, preferably at one end, for instance the lower edge, of the flooded region. In particular, such a point is also preferably rather at the front or at the rear, that is to say in relation to the typical central plane of symmetry of the toilet seat in this plane. Of the exemplary embodiment, this applies to a point at the rear-most end of the seat. At this point, any traces are particularly not noticeable. The same applies to the overflow channels which are advantageous during the flooding, cf. the exemplary embodiment.

The inflow channel for the first mold can be realized on an underside (again in relation to the mounted folded-down position of the toilet seat). This position is not noticeable.

In principle, the first mold and the second mold can be fundamentally different, wherein the composite removed from the first mold then has to be inserted into the second mold. Preferably, however, the two molds share a mold part, specifically in particular the one which adjoins the material introduced into the first mold. A mold part is then moved or exchanged, so to speak, on the other side, and a cavity which was previously not present is thus created in particular for the flooding.

According to the invention, the toilet seat manufactured in the manner described can be connected to a toilet cover. The toilet cover can also be manufactured, for example, by injection molding. Typically, both parts are connected in an articulated manner, wherein rotary dampers can be used. A toilet seat set is thus manufactured.

In addition, a toilet can also be manufactured with the toilet seat according to the invention, either by the toilet seat being mounted per se on a toilet body (on which a toilet cover can also be mounted, if necessary, independently of the toilet seat) or by the just-mentioned toilet seat set being attached to the toilet body.

The control and/or supply of the seat heating can, of course, take place from the toilet body or from a housing structure thereon, wherein line connections (in the classical sense of the galvanic contacts) are just as conceivable as “cordless” techniques, for instance by induction. Control elements can also be accommodated partly in the toilet seat and partly in the manner described. In addition, the toilet seat can, of course, also have a battery, in particular a rechargeable battery, a capacitor or the like for storing electrical energy.

The invention will be explained in more detail below on the basis of an exemplary embodiment, wherein the individual features can also be essential to the invention in another combination within the scope of the claims and also furthermore no distinction is made in detail between the different claim categories.

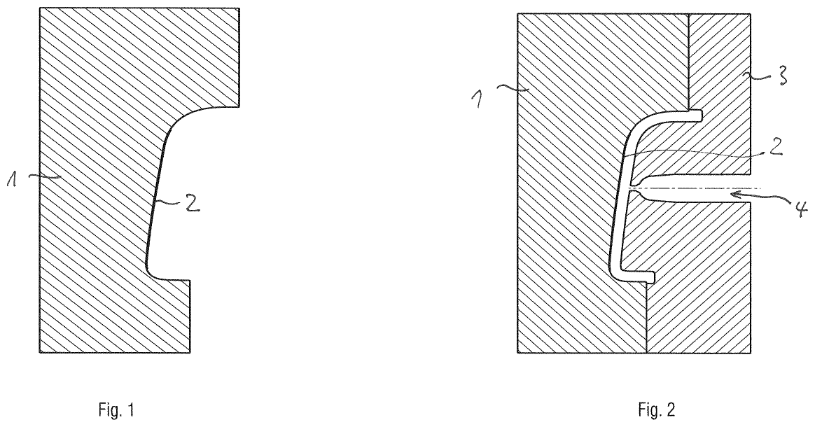

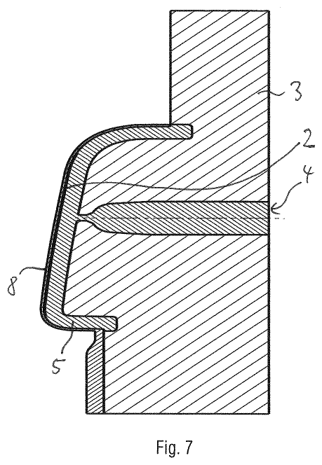

FIGS. 1-7 show, in a schematic sectional illustration, the manufacture according to the invention of a toilet seat, specifically in chronological order;

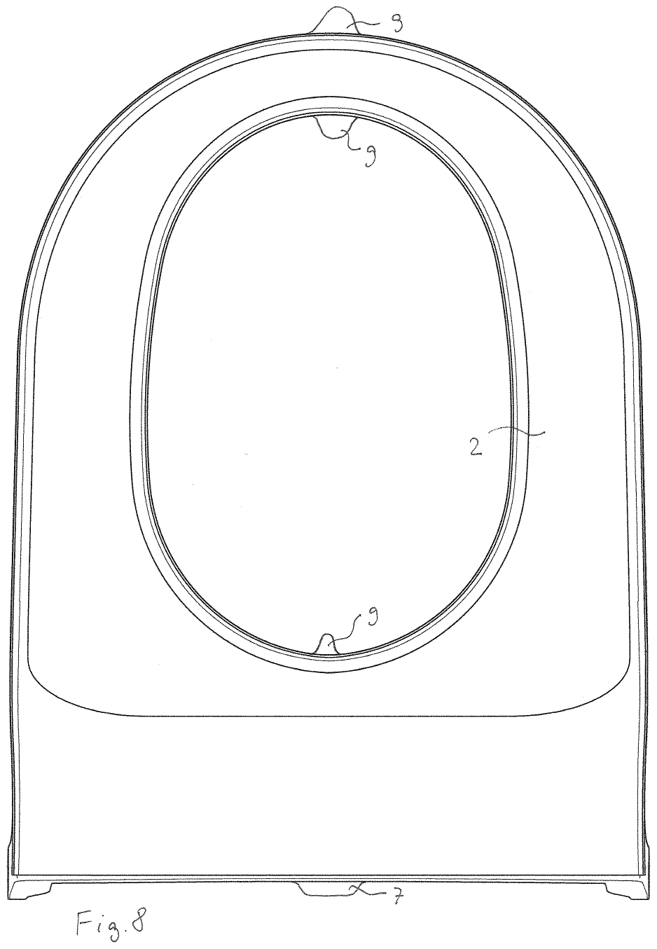

FIG. 8 shows a plan view of a finished toilet seat as the result of such a manufacturing method.

FIG. 1 illustrates, by 1, a mold part of an injection molding machine, wherein a seat heating 2 has been inserted into the mold part and specifically into a hollow mold formed therein. This insertion can be effected manually, but also mechanically, for instance by means of a vacuum device on a robot arm.

The seat heating 2 consists specifically of a plastic film, namely of ABS, which has, on the right-hand side in FIG. 1, a resistance heating of copper wire, wherein this resistance heating can be glued on, but for example can also have been lithographically structured from a layer previously deposited flat on the ABS film.

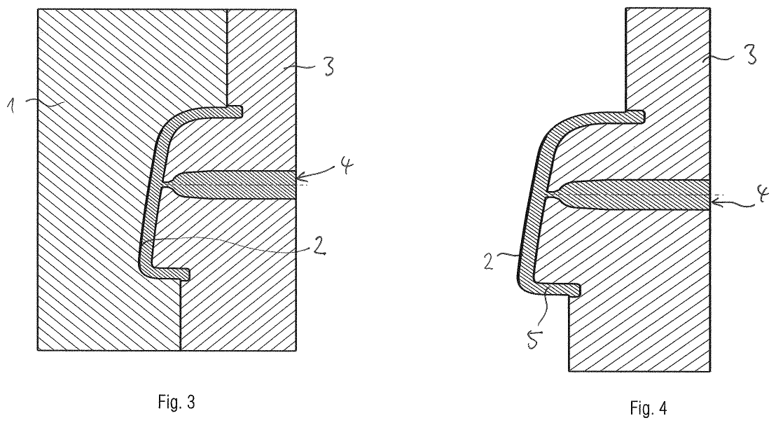

The seat heating 2 projects somewhat beyond the bottom of the hollow mold in a manner not visible in the schematic FIG. 1, in order to be clamped in there in the next step illustrated in FIG. 2. This is because it can be seen in FIG. 2 that a second mold part 3 has been placed from the right onto the mold part 1 already visible in FIG. 1, and a first injection molding mold 1, 3 has thus been defined. The second mold part 3 contains an inflow channel, visible in FIG. 2, for the heated thermoplastic material, namely ASA, for back-molding the seat heating 2. As a result of the two mold parts 1 and 3 being joined together, the seat heating 2 already slightly prefixed in its lower edge in FIG. 1 is clamped in a manner not illustrated between the two mold parts 1 and 3 and in this respect held there. Moreover, the seat heating 2 has a shape approximately matching the inner wall of the mold part 1, but is not yet completely defined in position.

Alternatively, the seat heating 2 could be prefixed, for example, in this lower region or else in another way on its left-hand side in FIGS. 1 and 2 by a vacuum device. Outlets of vacuum channels, if they are not too large, do not interfere with the injection molding process because of the carrier film of the seat heating 2.

As a result of the flowable ASA being introduced into the first injection molding mold 1, 3, which is already illustrated in the initial part in FIG. 2, the heated ASA bears from the right against the seat heating 2 arranged on the left in the first mold and presses this seat heating 2 increasingly against the left-hand outer wall of the first mold 1, 3. Together with the already mentioned clamping, a positional fixing thus occurs, wherein the injection molding material ensures good flat pressing of the seat heating 2 against the outer wall of the first mold and thus improves and ensures the positioning. In addition, the heated flowable ASA bears around the copper conductors on the ABS carrier film of the seat heating 2 and embeds the latter together with the carrier film. Finally, the injection molding material covers the entire right-hand side (or the upper side with respect to the lower part of the seat heating 2) of the seat heating 2, wherein the uppermost region of the first mold, which is approximately U-shaped in the section illustrated, is not covered by the seat heating 2.

FIG. 3 illustrates the state of the still closed first mold 1, 3 with complete filling.

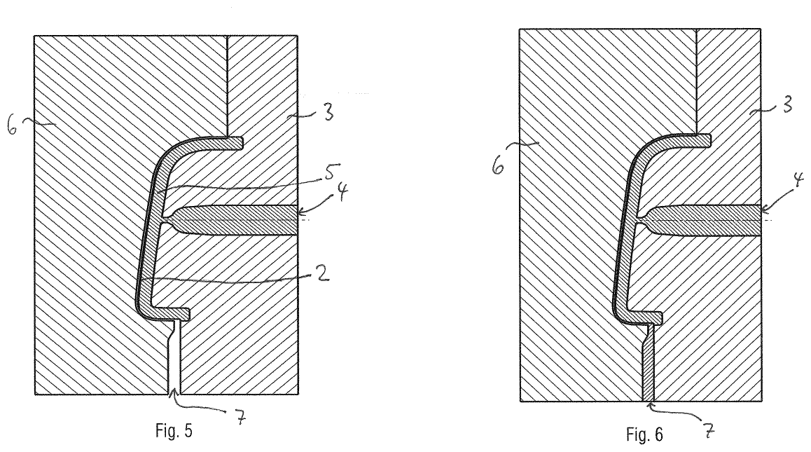

FIG. 4 shows the state after the opening of the first mold by moving the mold part 1 away from the mold part 3. In this state, the seat heating 2 and the lower shell 5, manufactured after the solidification of the ASA, of the future toilet seat remain at their point on the mold part 3. A third mold part 6 is subsequently moved from the left according to FIG. 5, which third mold part 6 together with the seat heating 2 or, where it no longer exists, the lower shell 5 forms a cavity for a flooding. The combination of the two mold parts 3 and 6 is subsequently referred to as the second mold, wherein the previously molded lower shell 5 with the seat heating 2 thereon reduces and delimits the actual cavity for the flooding. In this case, polyurea (or else polyurethane) is inserted in a flowable state through an inlet channel 7, which is illustrated symbolically in the lower part of FIG. 5, until the second mold 3, 6 is completely filled and the polyurea material emerges through overflow channels (not illustrated) in the upper region.

In FIG. 6, the second mold 3, 6 is correspondingly filled and not yet in FIG. 5. It can also be seen in comparison that the cavity to be filled is comparatively very small, because it is intended to form only a small material thickness in the range between 0.5 to 1 mm.

After the solidification of the polyurea material by a chemical reaction therein (that is to say after the chemical curing), the second mold 3, 6 can be opened and the combination now produced can be removed in the sense of a layered composite from the lower shell 5, the seat heating 2 (that is to say copper resistance heating on carrier film) and, thereon or to the left next to the polyurea flooding layer 8.

The finished product is shown in FIG. 8 in a more realistic plan view, wherein the inlet channel is denoted by the already used reference sign 7, but here has a position at the very rear and rear of the toilet seat in relation to the position of a toilet user. 9 denotes three overflow channels which lie at the bottom at an edge in the use position of the toilet seat. 2 denotes the seat heating. It goes without saying that the U-shaped cross-sectional profile illustrated in FIGS. 1-7 corresponds to a section through the toilet seat with a section plane perpendicular to FIG. 8 and the position of the inlet channel 7 and of the overflow channels 9 has been illustrated symbolically in FIGS. 1-7.

The polyurea material (or else polyurethane) used for the actual use surface has outstanding properties with regard to the visual appearance, the durability, the color fastness and the insensitivity to light and cleaning agents, skin contact and cosmetic chemicals. At the same time, the lower shell 5 of injection-molded ASA has a very good dimensional fidelity and requires in particular no or only a marginal reworking effort. In this case, the seat heating 2 is accommodated extremely close to the surface in the uppermost region of the toilet seat and is therefore suitable for an energy-efficient and reaction-fast and precisely controllable mode of operation. The energy efficiency can also be of particular advantage, for example, when using cordless energy transmission to the seat heating. In addition, relatively low voltages can be used, which is beneficial to safety or reduces or avoids effort for safety measures.

Of course, further parts, in particular electrical or electronic components, can be integrated during the manufacture, in particular in the lower shell 5, and the U-shaped cross-sectional shape can be varied just like the mold in the plan view of FIG. 8.

The exemplary embodiment shows an advantageous combination of two manufacturing methods. In this case, the injection molding carried out in the first mold is relatively rapid and also economical in the case of larger quantities. On the other hand, the flooding in the second mold allows the use of very advantageous materials which, as second-component materials (plus dye, if necessary), are not accessible to the injection molding but cure chemically from themselves. Together with the injection molding, an outstanding surface quality results in this case and adhesive joints or weld joints or other separating edges (such as, for instance, when separately manufactured shells are joined together) can be avoided. The flooding also avoids a perceptible film edge at the edge of the seat heating.

1. A method of manufacturing a toilet seat comprising the steps of:
providing a seat heating,
inserting the seat heating into a first mold,
filling the first mold on a first side of the seat heating with a flowable material,
solidifying the material to produce a composite of the seat heating and the solidified material in the first mold.

2. The method according to claim 1, wherein the seat heating is inserted into the first mold on a carrier film, preferably of ABS, and preferably the carrier film thereafter remains in the first mold and in the composite produced.

3. The method according to claim 2, wherein an electrical heating conductor of the seat heating is provided on a lower side of the carrier film.

4. The method according to claim 1, wherein the seat heating is deformed by the flowable material during the filling of the first mold.

5. The method according to claim 1, wherein the filling of the first mold with and the solidifying of the material in the first mold corresponds to an injection molding method and the material is thermoplastic, preferably ASA.

6. The method according to claim 5, comprising the additional step of:
flooding the composite on a second side of the seat heating in a second mold after the solidifying of the material, wherein the second mold is preferably closed, wherein a flooding material is used in a flowable state and then solidifies in the second mold.

7. The method according to claim 6, wherein an inflow channel to the second mold and an overflow channel of the second mold are used for the flooding material, which channels open laterally into the cavity of the second mold with respect to a cross-section through the toilet seat, preferably at one end of the flooded region.

8. The method according to claim 6, wherein a part of the second mold is already used as part of the first mold.

9. The method according to claim 5, optionally also in conjunction with a further one of the preceding claims, wherein an inflow channel to the first mold is used for the inflow of the thermoplastic material, which inflow channel opens into the cavity of the first mold on a lower side.

10. A method of manufacturing a toilet seat set, in which method a toilet seat is manufactured according to claim 1 and is connected to a toilet cover.

11. A method of manufacturing a toilet, in which a toilet seat is manufactured according to claim 1 and the toilet seat is connected to a toilet body, wherein the toilet seat is first connected to a toilet cover which is then connected to the toilet body.
